(19) United States
(12) Patent Application Publication
(10) Pub. No.: US 2016/0050378 A1
(43) Pub. Date: Feb. 18, 2016

(54) PIXEL SENSOR DEVICE AND OPERATING METHOD THEREOF

(71) Applicant: ELAN MICROELECTRONICS CORPORATION, Hsin Chu (TW)

(72) Inventors: Po-Hao WU, Zhubei City (TW); Chun-Kai LIU, Hsinchu City (TW)

(73) Assignee: ELAN MICROELECTRONICS CORPORATION

(21) Appl. No.: 14/727,121

(22) Filed: Jun. 1, 2015

(30) Foreign Application Priority Data
Aug. 14, 2014 (TW) 103127955

(51) Int. Cl. H04N 5/369; H04N 5/343; G06K 9/00; H04N 5/378

(52) U.S. Cl. CPC H04N 5/3696; H04N 5/378; H04N 5/3698; H04N 5/343; G06K 9/00013

(57) ABSTRACT

A pixel sensor device has a first sensing unit, a second sensing unit, a first control and reading unit, and a second control and reading unit. The first and second sensing units are disposed concentrically. The first and second control and reading units are connected respectively to the first and second sensing units for separately or simultaneously controlling the first and second sensing units to perform sensing. Since the first and second sensing units are formed by a single pixel sensing array and arranged concentrically, only a single focusing element is required to align centers of the first and second sensing units during the manufacturing process. This achieves high focus accuracy and increases precision in recognition. In the applications of fingerprint recognition and pulse measurement, the user only uses a single finger for sensing so that inaccurate focusing resulted from moving finger is avoided.

### BACKGROUND OF THE INVENTION

1. Field of the Invention

The invention relates to an active pixel sensor device and the operating method thereof In particular, the invention relates to a pixel sensor device using a single pixel sensing array to provide different applications.

2. Description of Related Art

There are two types of optical sensor devices for fingerprint recognition. One is the passive pixel sensor (PPS) device, and the other is the active pixel sensor (APS) device. In both types of pixel sensor devices, fingerprint recognition is carried out by resetting sensing pixels of the pixel sensor device, exposing the sensing pixels, reading sensing currents of the sensing pixels, and converting the sensing currents into corresponding sensing voltages. However, in addition to the fingerprint recognition function, there are many other optical sensing applications, such as detecting ambient brightness and detecting pulses. The pulse detection is performed by detecting the contraction and expansion of micro blood vessels. The resolution required by such application is lower than that required by fingerprint recognition.

To integrate the above-mentioned two applications, the optical sensor device usually has an APS device and a photo sensor device. As shown in FIG. 7, the APS device 60 includes an active pixel sensing array 601, a reset and selection circuit 61, and a signal reading circuit 62. Before the active pixel sensing array 601 has an exposure, the reset and selection circuit 61 resets each sensing pixel P11˜Pmn on the active pixel sensing array 601 in sequence, then exposes the active pixel sensing array 601. After the exposure is complete, the reset and selection circuit 61 selects the sensing pixels in a row, and the signal reading circuit 62 reads sensing voltages corresponding to the sensing currents. The photo sensor device 70 includes a photo sensing array 701 and a signal reading circuit 72. The sensing pixels of the photo sensor array 701 have a relative larger photo sensing area. Therefore, after the photo sensor array 701 is reset and exposed, the sensing current detected by the signal reading circuit 72 is converted into a corresponding sensing voltage. The sensing voltage is used to determine the intensity of the ambient brightness or the variation in the contraction and expansion of micro blood vessels on a finger.

Accordingly, to integrate two or more different applications, the optical sensor device has to use two different sensors, such as the active pixel sensing array 601 and the photo sensing array 701. Moreover, the two different sensing arrays have different circuit designs, and result in increasing both the cost and size of the entire device. In the example of having fingerprint recognition and pulse measurements, the user needs to place his finger on different regions corresponding to the different sensors for different purposes. Such operation is not convenient.

Moreover, such a dual-application optical sensor device has the active pixel sensing array 601 and the photo sensing array 701 formed in different regions. If only a single focusing element is used, it is difficult to have a precise focus because the active pixel sensing array 601 and the photo sensing array 701 are not in the same region. If two focusing elements are used for the active pixel sensing array 601 and the photo sensing array 701respectively, the cost becomes higher and the control circuit gets more complicated.

### SUMMARY OF THE INVENTION

An objective of the invention is to provide a pixel sensor device using a single pixel sensing array to provide several different applications.

To achieve the above-mentioned objective, the active pixel sensor device includes:

a first sensing unit including a plurality of first sensing pixels;

a second sensing unit including a plurality of second sensing pixels, wherein the first sensing pixels are disposed around an outer edge of the second sensing pixels and the first and second sensing units are disposed concentrically;

a first signal reading unit connecting to all the first sensing pixels for detecting a summation of sensing currents flowing through all the first sensing pixels; and

a second control and reading unit connecting to each second sensing pixel for reading individually a sensing voltage of each second sensing pixel.

The first and second sensing units of the pixel sensor device all exist on a single pixel sensing array. The first signal reading unit and the second control and reading unit can perform detections separately or simultaneously, thereby implementing two different applications. Since the first and second sensing units are configured concentrically, only a single focusing element is required to focus at the center of the first and second sensing units in the fabrication. This can achieve accurate focusing and increase the precision in recognition. For the dual applications of fingerprint recognition and pulse measurement, the user only needs to use one finger. This avoids the problem of imprecise measurements as a result of being out of focus as the user moves fingers.

### BRIEF DESCRIPTION OF THE DRAWINGS

FIG. 1A is a circuit block diagram of the pixel sensor device of the invention;

FIG. 1B is another circuit block diagram of the pixel sensor device of the invention;

FIG. 2A is a detailed circuit diagram of part of the first sensing unit and the first signal reading unit in the first embodiment of the invention;

FIG. 2B is another detailed circuit diagram of part of the first sensing unit and the first signal reading unit in the first embodiment of the invention;

FIG. 3 is a detailed circuit diagram of part of the second sensing unit in the first embodiment of the invention;

FIG. 4A is a detailed circuit diagram of part of the first sensing unit and the first signal reading unit in the second embodiment of the invention;

FIG. 4B is another detailed circuit diagram of part of the first sensing unit and the first signal reading unit in the second embodiment of the invention;

FIG. 5 is yet another circuit block diagram of the pixel sensor device;

FIG. 6 is a flowchart of the operating method of the pixel sensor device; and

FIG. 7 is a circuit block diagram of a conventional optical sensor device that integrates two applications.

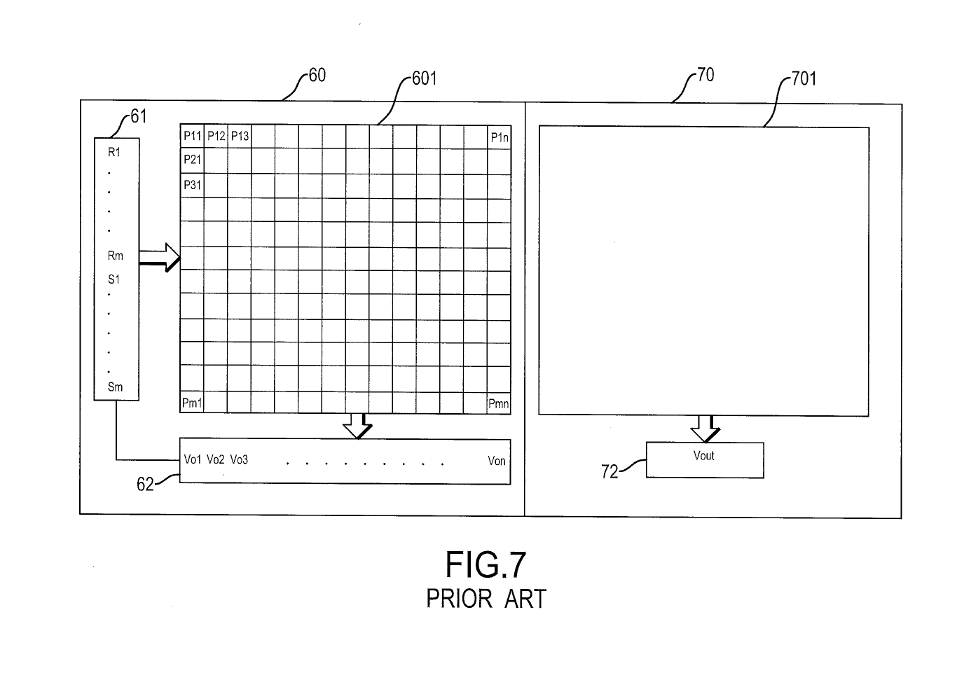

### DETAILED DESCRIPTION OF THE PREFERRED EMBODIMENT

This invention proposes a pixel sensor device. It uses the design of a single pixel sensing array that can separately or simultaneously support different applications. The contents of the invention are explained in example of following embodiments.

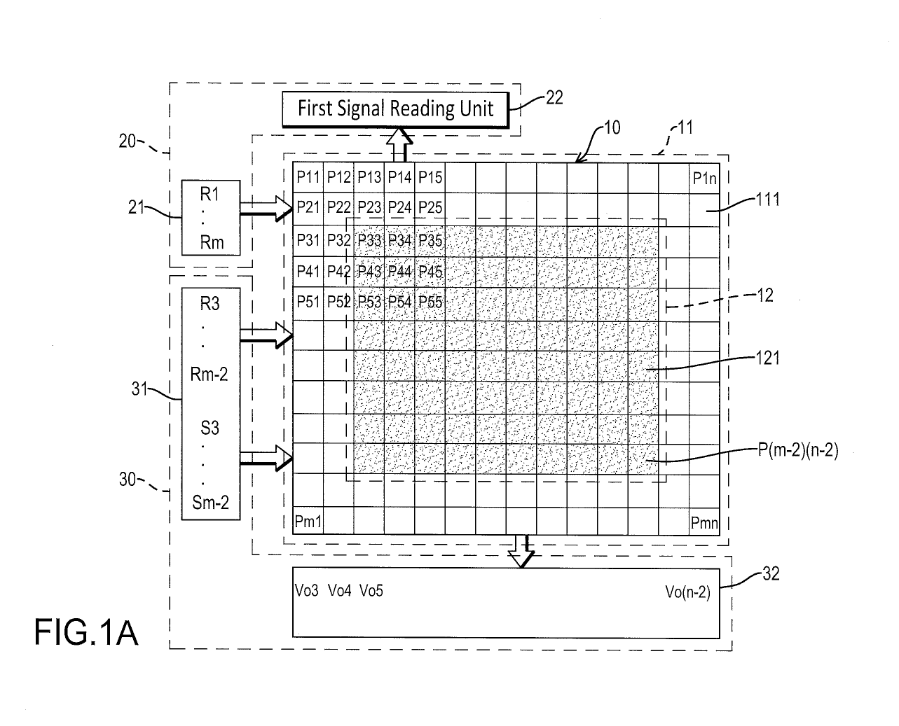

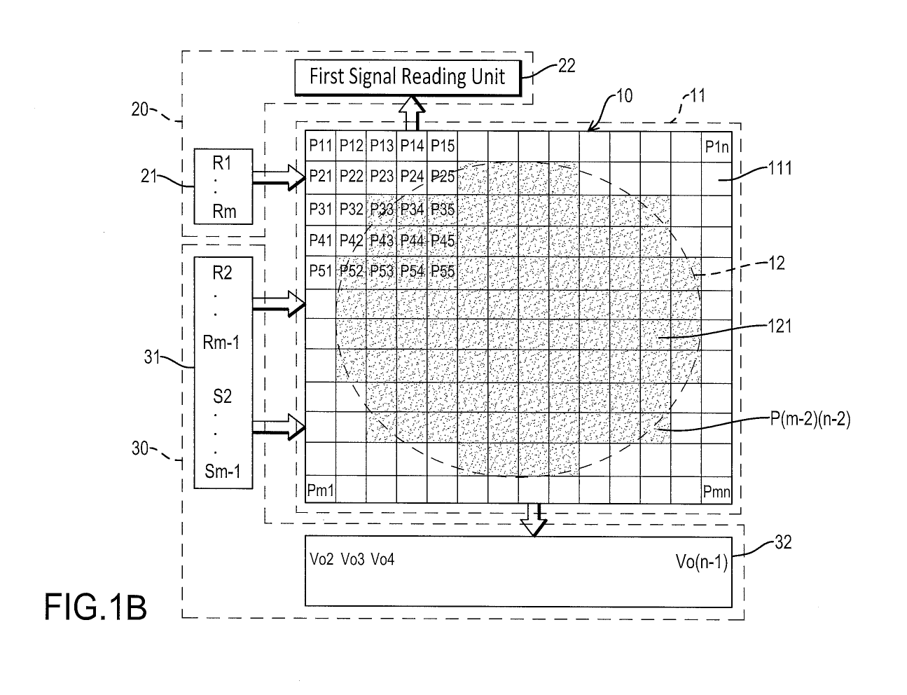

With reference to FIG. 1A, the pixel sensor device includes a first sensing unit 11, a second sensing unit 12, a first control and reading unit 20, and a second control and reading unit 30.

The first and second sensing units 11, 12 are formed by a single pixel sensing array 10. The first sensing unit 11 includes a plurality of first sensing pixels 111 disposed annularly and indicated by the white squares. The second sensing unit 12 also includes a plurality of second sensing pixels 121 indicated by the gray squares. All of the first sensing pixels 111 surround the second sensing unit 12, so that the first sensing unit 11 and the second sensing unit 12 are concentric. As shown in FIG. 1A, the first sensing unit 11 has an annular square shape. The second sensing pixels 121 of the second sensing unit 12 are disposed in a matrix shape. Alternatively, as shown in FIG. 1B, the first sensing unit 11 has a square outer shape and an approximate circular inner shape. Therefore, the second sensing unit 12 is disposed in an approximate circular shape for making corresponding detections. Therefore, the first and second sensing units 11, 12 are also concentric. In this embodiment, the pixel sensing array 10 has m rows and n columns. The second sensing unit 12 includes pixels between the third row and the (m-2)th row and between the third column and the (n-2)th column. The other pixels belong to the first sensing unit 11.

The first control and reading unit 20 connects to all the sensing pixels 111 of the first sensing unit 11 for detecting a current sum Isum, i.e. a summation of sensing currents flowing through all the first sensing pixels 111 of the first sensing unit 11. The first control and reading unit 20 further converts the current sum Isum into an output signal, which can be an output voltage or output current.

The second control and reading unit 30 connects to all the sensing pixels 121 of the second sensing unit 12 for reading a sensing signal, such as a sensing voltage, of each second sensing pixel 121 of the second sensing unit 12.

The following example uses two embodiments with pixel sensing arrays 10 using different sensing pixels to explain the detailed circuit diagrams and circuit actions of the first and second control and reading units 20, 30.

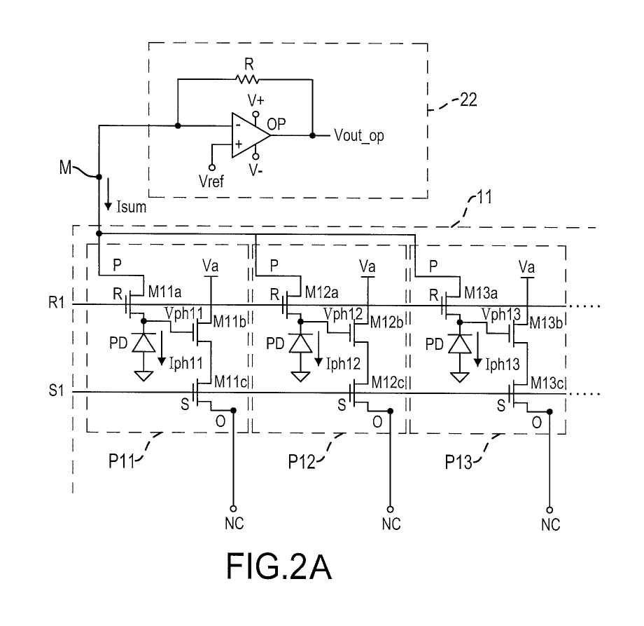

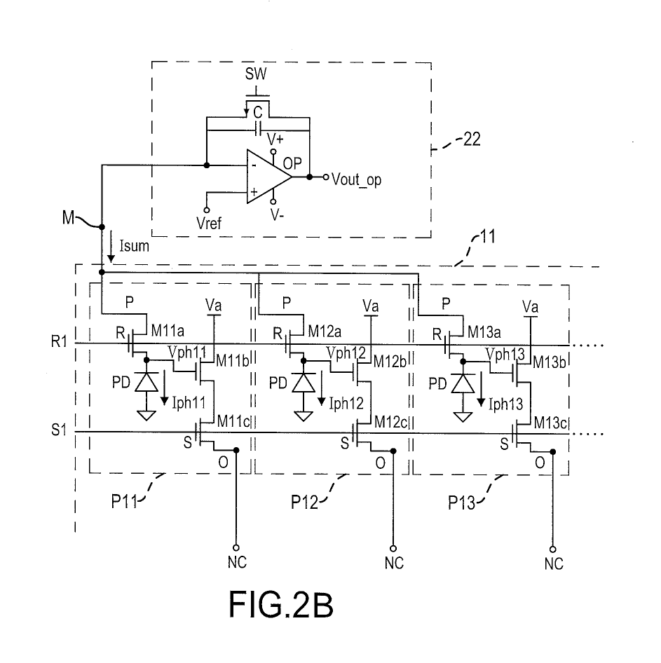

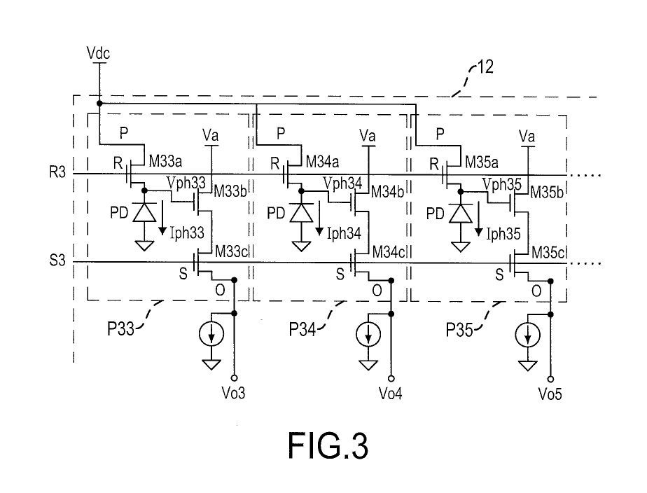

FIG. 1A is a circuit block diagram of a pixel sensor device. FIG. 2A is a detailed circuit diagram of part of the first sensing unit 11 and the first signal reading unit 22 in FIG. 1A. FIG. 3 is a detailed circuit diagram of part of the second sensing unit 12 in FIG. 1A. As shown in FIGS. 1A, 2A, and 3, the first and second sensing pixels 111, 121 of the first and second sensing units 11, 12 are all active sensing pixels. The active sensing pixels, such as the pixels P11, P33, may have the 3T-APS (active pixel sensor) structure. The pixels P11, P33 represent respectively the circuit structures of the first sensing pixel 111 and the second sensing pixel 121. Each of the first and second sensing pixels 111, 121 includes a power terminal P, a reset terminal R, a selection terminal S, and an output terminal O. Each of the sensing pixels includes a reset switch M11a, M33a, a source follower M11b, M33b, a selection switch M11c, M33c, and a photo detector PD. The reset switch M11a, M33a is a metal-oxide-semiconductor field-effect transistor (MOSFET) that includes a drain connecting to the power terminal P, a gate connecting to the reset terminal R, and a source connecting to the photo detector PD. The source follower M11b, M33b can also be a MOSFET that includes a drain connecting to an operating power Va, a gate connecting to the source of the reset switch M11a, M33a, and a source connecting to the selection switch M11e, M33c. The selection switch M11c, M33c can also be a MOSFET which includes a drain connecting to the source of the source follower M11b, M33b, a gate connecting to a selection terminal S, and a source connecting to the output terminal O. The source of the selection switch M11c of the first sensing pixel 111 can have no connection (NC), as shown in FIGS. 2A and 2B, or connect to the second control and reading unit 30, and both connection configurations do not affect the function of the first sensing pixel 111. The output terminal O of the selection switch M33c of the second sensing pixel 121 (as shown in FIG. 3) connects to a voltage output terminal Vo3 of the second control and reading unit 30. A cathode of the photo detector PD connects to the source of the reset switch M11a, M33a. An anode of the photo detector PD connects to a ground terminal The photo detector PD obtains charges after the reset switch M11a, M33a becomes conductive. Under the exposure of light, the charges of the photo detector PD decline at a rate with a positive correlation to the intensity of the light source. Besides, each of the active sensing pixels may have the 4T-APS structure rather than limited to the 3T-APS structure. In the first sensing unit 11 and the second sensing unit 12, the reset terminals R of the pixels in the same row are connected together, and the selection terminals S of the pixels in the same row are connected together. In the second sensing unit 12, the output terminals O of the pixels in the same column are connected together and to the corresponding voltage output terminals Vo3˜Vo(n-2) of the second control and reading unit 30.

With reference to FIGS. 1A and 2A, the power terminals P of all the pixels in the first sensing unit 11 connect to a measuring terminal M. The first control and reading unit 20 includes a first reset and selection unit 21, which has a plurality of reset terminals R1 to Rm connecting respectively to the switches of the first sensing pixels 111, so as to output a reset signal to the switches of the first sensing pixels 111 simultaneously. After all the first sensing pixels 111 are exposed to light, the first control and reading unit 20 detects the current sum Isum flowing through all of the first sensing pixels 111 via the measuring terminal M. More explicitly, the first control and reading unit 20 may further include a first signal reading unit 22 that connects to the power terminals P of all first sensing pixels 111 via the measuring terminal M. After converting the detected current sum Isum into an output signal, the first control and reading unit 20 outputs the output signal as optical sensing information. The output signal can be an output voltage or an output current. In a different embodiment, the first reset and selection unit 21 can also provide only one reset terminal R that connects to the reset terminals R of all the first sensing pixels 111 through external conductive wires.

As shown in FIG. 2A, the first signal reading unit 22 includes an operational amplifier OP and a resistor R. The work voltage required by the operational amplifier OP can come from the operating power Va or other DC sources. A non-inverting input terminal (+) of the operational amplifier OP connects to a reference voltage Vref, and an inverting input terminal (−) of the operational amplifier OP connects to the power terminals P of the first sensing pixels 111(i.e., P11, P12, P13) via the measuring terminal M. The resistor R connects between the inverting input terminal (−) and the output terminal Vout_op of the operational amplifier OP. As shown in FIG. 2B, the first signal reading unit 22′ in another embodiment can also include an operational amplifier OP, a capacitor C, and a switch SW. The work voltage required by the operational amplifier OP can come from the operating power Va or other DC sources. The non-inverting input terminal (+) of the operational amplifier OP connects to a reference voltage Vref, and the inverting input terminal (−) of the operational amplifier OP connects to the power terminals P of the first sensing pixels 111 via the measuring terminal M. The capacitor C connects between the inverting input terminal (−) and the output terminal Vout_op of the operational amplifier OR The switch SW connects in parallel with the capacitor C. The work power required by each of the first sensing pixels 111 can be the same as the reference voltage Vref of the operational amplifier OP. Due to the fact that the operational amplifier OP is connected to the virtual ground, the inverting input terminal (−) of the operational amplifier OP has a voltage level equivalent to the reference voltage Vref of the non-inverting input terminal (+).

When the first sensing unit 11 of this embodiment performs the application such as ambient light detection or pulse measurement, the power terminals P of all the first sensing pixels 111 are connected with the inverting input terminal (−) of the operational amplifier OP of the first signal reading unit 22. The first reset and selection unit 21 outputs a reset signal via the reset terminals R1˜Rm so that the reset switches of all the first sensing pixels 111 become conductive. The photo detector PD is then reversely biased at the voltage Vref, followed by exposure. The photo detectors PD of all the first sensing pixels 111 generate their sensing currents. The operational amplifier OP of the first signal reading unit 22 obtains the current sum Isum from the measuring terminal M, and converts the current sum Isum into an output voltage. The output voltage is output via the output terminal Vout_op of the operational amplifier OP as optical sensing information. Since all the first sensing pixels 111 are simultaneously charged and exposed to light, the invention provides a large optical sensing area for such applications as ambient light detection or pulse measurement.

With reference to FIGS. 1A and 3, the second control and reading unit 30 includes a second reset and selection unit 31 and a second signal reading unit 32. In this embodiment, the second sensing pixels 121 are also active sensing pixels. The second reset and selection unit 31 has a plurality of reset terminals R3˜Rm-2 connecting respectively to the reset switches of the second sensing pixels 121(such as P33, P34, P35 in FIG. 3) for outputting a reset signal to the switch of each second sensing pixel 121 and outputting a selection signal to the selection terminal S3 of each second sensing pixels 121. The voltage output terminals Vo3˜Vo(n-2) of the second signal reading unit 32 connect respectively to the output terminals O of the second sensing pixels 121 in each column for reading the sensing current produced by the stored charges in the photo detectors PD in each of the second sensing pixels 121 in each column due to light exposure, or reading the sensing voltage corresponding to the sensing current.

The reset terminals R of the second sensing pixels 121 in the same row are connected together, and the selection terminals S thereof are connected together as well. Therefore, the second sensing pixels 121 in the same row can be simultaneously reset and selected. After row sensing data of the sensing pixels 121 in the same row are read out, the row sensing data can be decoded to obtain individual sensing data of the second sensing pixels 121. Since the decoding technique is well-known to a person skilled in the art, it is not further described herein. In addition to the above-mentioned connection scheme, one can also connect the reset terminal R and the selection terminal S of each of the second sensing pixels 121 separately to the second reset and selection unit 31, so that the second reset and selection unit 31 can independently reset and select the second sensing pixels 121. Besides, another feasible scheme is to connect all the second sensing pixels 121 together before further connecting to the second reset and selection unit 31. Therefore, all of the second sensing pixels 121 are simultaneously reset and selected. After the sensing data of all the second sensing pixels 121 are read out, the sensing data are decoded to obtain individual sensing data of each of the sensing pixels.

When the second sensing unit 12 of this embodiment performs the application of fingerprint recognition, the second reset and selection unit 31 outputs a reset signal to the reset terminal R of each second sensing pixel (using the second sensing pixel P33 as an example), thereby resetting the voltage of the photo detector PD. Under light exposure, the photo detector PD generates a sensing current. The second reset and selection unit 31 further outputs the selection signal to the selection terminal S of the second sensing pixel 121 which have been reset, thereby making the selection switch thereof conductive. The second signal reading unit 32 reads the sensing voltages of the voltage output terminals Vo3˜Vo(n-2). Thus the sensing voltage of each second sensing pixel 121 that scans the fingerprint for fingerprint recognition is obtained.

A second embodiment of the invention is described as follow. As shown in FIGS. 1A, 3, and 4A, the first sensing pixels 111 of the first sensing unit 11 are passive sensing pixels, and the second sensing pixels 121 of the second sensing unit 12 are active sensing pixels, wherein the second sensing pixels 121 are the same as the first embodiment and are not further described here. The passive sensing pixel includes a power terminal P, a reset terminal S, a reset switch M11, and a photo detector PD. The reset switch M11 can be a MOSFET that includes a drain connecting to the power terminal S, a gate connecting to the reset terminal R (taking the first sensing pixel P11 as an example), and a source connecting to the cathode of the photo detector PD. The anode of the photo detector PD connects to a ground terminal. Therefore, the photo detector PD obtains charges when the reset switch M11 becomes conductive, and the charges decline at a rate with a positive correlation to the intensity of the light source. Besides a passive sensing pixel, each of the first sensing pixels 111 of the first sensing unit 11 in another embodiment can be a photo detector PD without the reset switch M11. The cathode of the photo detector PD connects to the power terminals P of the first sensing pixels 111 in order to connect to the first signal reading unit 22. Under this structure, the first reset and selection unit 21 in FIG. 1A is not required.

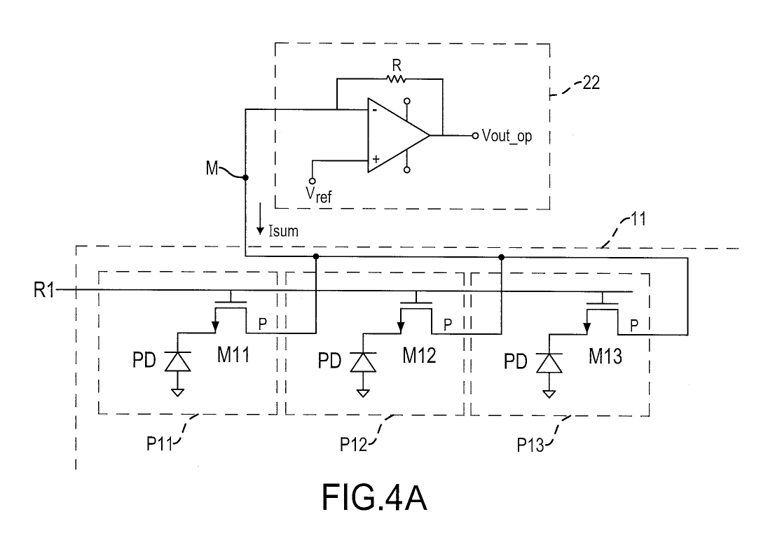

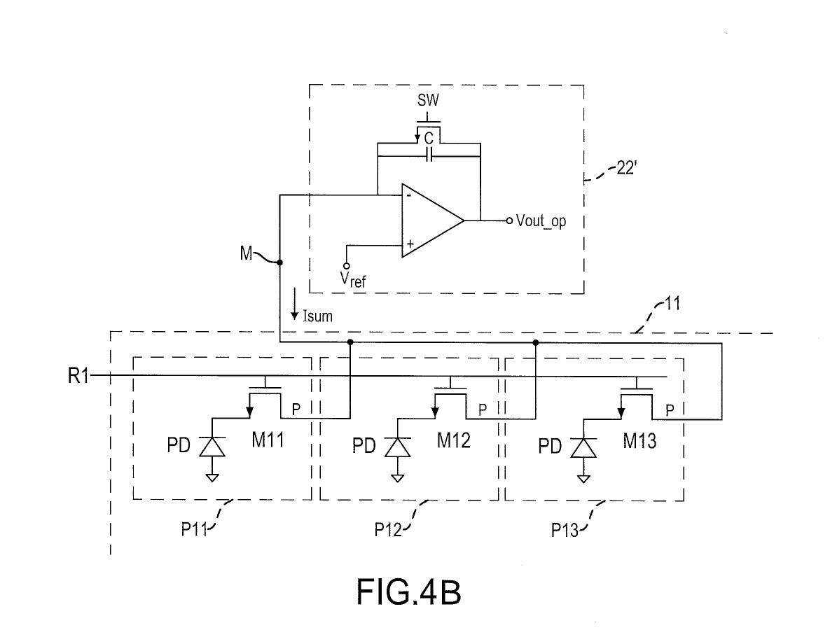

The first control and reading unit 20 in this embodiment is the same as that in the first embodiment. That is, the first control and reading unit 20 includes a first reset and selection unit 21 or further includes first signal reading units 22, 22′. The first signal reading units 22, 22′ are shown in FIGS. 4A and 4B and are the same as those in FIGS. 2A and 2B. Therefore, they are not further described here again.

When the first sensing unit 11 of this embodiment performs such an application as ambient light detection or pulse measurement, the power terminals P of all the first sensing pixels 111 connect to the inverting input terminal (−) of the operational amplifier OP of the first signal reading unit 22. The first reset and selection unit 20 outputs the reset signal to the reset terminals R of all the first sensing pixels 111, so that the photo detectors PD are biased at the voltage Vref. After exposure to light, the photo detectors PD of all the first sensing pixels 111 produce sensing currents. The operational amplifier OP of the first signal reading unit 22 obtains a current sum Isum, i.e. a summation of the sensing currents, converts the current sum Isum into an output voltage, and outputs the output voltage via the output terminal Vout_op of the operational amplifier OP as optical sensing information. Since all the first sensing pixels 111 are simultaneously charged and exposed to light, a larger optical sensing area is achieved to detect the intensity of ambient brightness or to measure pulses by detecting the contraction and expansion of finger blood capillaries. The application of fingerprint recognition by the second sensing unit 12 is the same as that in the first embodiment.

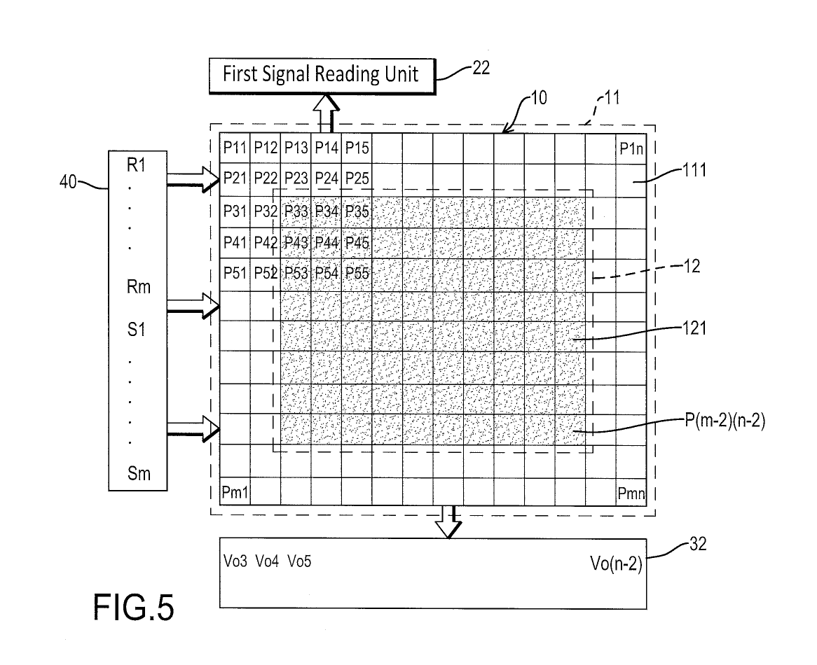

It is clear from the above description that the first and second reset and selection units 21, 31 in either the first embodiment or the second embodiment are connected respectively to the first and second sensing pixels 111, 121 and have the same functions. Therefore, as shown in FIG. 5, the first and second reset and selection units 21, 31 can be further integrated into a single reset and selection unit 40.

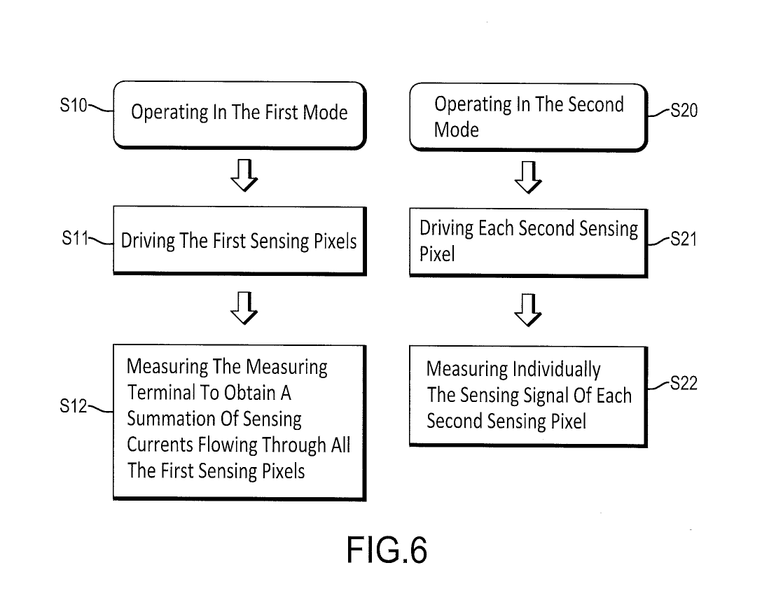

With reference to FIG. 6, the operating method of the active pixel sensor device can be summarized into one operating in the first mode S10 and the other operating in the second mode S20. Under the first mode, the method includes the steps of: driving the first sensing pixels (step S11); and measuring the measuring terminal to obtain a summation of sensing currents flowing through all of the first sensing pixels (step S12). Under the second mode, the method includes the steps of: driving each second sensing pixel (step S21); and measuring individually the sensing signal of each second sensing pixel (step S22).

The first sensing unit 11 and the second sensing unit 12 of the invention are disposed concentrically. Not only does this scheme save the area in manufacturing, only a single focusing element is required to focus at the center of the first sensing unit 11 and the second sensing unit 12. This can readily achieves the effect of focusing accurately and increasing the resolution of recognition.

When making the sensing pixels for fingerprints recognition, such as the second sensing pixels 121 of the second sensing unit 12, the surrounding of these sensing pixels is formed with several dummy pixels to ensure the symmetry property of the sensing pixels for fingerprints recognition. Therefore, the invention can directly use the dummy pixels as the first sensing pixels 111. In this case, the original dummy pixels become useful and have the function of detection, supporting different applications (e.g., the above-mentioned ambient light detection or pulse measurement) without purposely making additional sensing pixels.

In summary, the invention divide the pixel sensing array into the first and second sensing units disposed concentrically in order to perform sensing by the first and second control and reading units. The first control and reading unit connects to all the first sensing pixels and, therefore, can detect the summation of sensing currents flowing through all the sensing pixels, thereby realizing large-area sensing. The second control and reading unit reads individually the second sensing pixels of the second sensing unit for implementing high-resolution fingerprint recognitions. Consequently, the invention only requires a single pixel sensing array to provide applications of high-resolution fingerprint recognitions integrated with ambient light or pulse measurement. It has the advantage of lower cost, simpler circuit, and smaller size. The user only needs to place his finger at the pixel sensing array, relatively easy in use. The first and second sensing units are disposed concentrically. When the user puts a single finger for measurement, the invention can avoid the problem of imprecise measurements as a result of being out of focus as the user moves fingers.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pixel sensor device, comprising:
a first sensing unit including a plurality of first sensing pixels;
a second sensing unit including a plurality of second sensing pixels, wherein the first sensing pixels are disposed around an outer edge of the second sensing pixels and the first and second sensing units are disposed concentrically;
a first signal reading unit connecting to all the first sensing pixels for detecting a summation of sensing currents flowing through all the first sensing pixels; and
a second control and reading unit connecting to each second sensing pixel for reading individually a sensing voltage of each second sensing pixel.

2. The pixel sensor device as claimed in claim 1, wherein
each second sensing pixel is an active sensing pixel, and has a power terminal, a reset terminal, a selection terminal, and a voltage output terminal, with the power terminal of the second sensing pixel connecting to a work power; and
the second control and reading unit comprises:
a second reset and selection unit connecting to the reset terminal of each second sensing pixel for outputting a reset signal to the reset terminal of each second sensing pixel and outputting a selection signal to the selection terminal of each second sensing pixel; and
a second signal reading unit connecting to the voltage output terminal of each second sensing pixel for reading a sensing signal of each second sensing pixel.

3. The pixel sensor device as claimed in claim 2, wherein
each first sensing pixels is an active sensing pixel, and has a power terminal and a reset terminal, with the power terminal of the first sensing pixel connecting to the first signal reading unit; and
the pixel sensor device further comprises:
a first reset and selection unit connecting to the reset terminal of each first sensing pixel for simultaneously outputting a reset signal to the reset terminal of each first sensing pixel.

4. The pixel sensor device as claimed in claim 2, wherein
each first sensing pixel is a passive sensing pixel, and has a power terminal and a reset terminal, with the power terminal of the first sensing pixel connecting to the first signal reading unit; and
the pixel sensor device further comprises:
a first reset and selection unit connecting to the reset terminal of each first sensing pixel for simultaneously outputting a reset signal to the reset terminal of each first sensing pixel.

5. The pixel sensor device as claimed in claim 3, wherein the first and second reset and selection units are integrated into a single reset and selection unit.

6. The pixel sensor device as claimed in claim 4, wherein the first and second reset and selection units are integrated into a single reset and selection unit.

7. The pixel sensor device as claimed in claim 3, wherein the first signal reading unit comprises:
an operational amplifier having an inverting input terminal, a non-inverting input terminal, and an output terminal, with the inverting input terminal connecting to the power terminal of each first sensing pixel and the non-inverting terminal connecting to a reference voltage; and
a resistor connecting between the inverting input terminal and the output terminal of the operational amplifier.

8. The pixel sensor device as claimed in claim 4, wherein the first signal reading unit comprises:
an operational amplifier having an inverting input terminal, a non-inverting input terminal, and an output terminal, with the inverting input terminal connecting to the power terminal of each first sensing pixel and the non-inverting terminal connecting to a reference voltage; and
a resistor connecting between the inverting input terminal and the output terminal of the operational amplifier.

9. The pixel sensor device as claimed in claim 3, wherein the first signal reading unit comprises:
an operational amplifier having an inverting input terminal, a non-inverting input terminal, and an output terminal, with the inverting input terminal connecting to the power terminal of each first sensing pixel and the non-inverting terminal connecting to a reference voltage;
a capacitor connecting between the inverting input terminal and the output terminal of the operational amplifier; and
a switch connecting in parallel with the capacitor.

10. The pixel sensor device as claimed in claim 4, wherein the first signal reading unit comprises:
an operational amplifier having an inverting input terminal, a non-inverting input terminal, and an output terminal, with the inverting input terminal connecting to the power terminal of each first sensing pixel and the non-inverting terminal connecting to a reference voltage;
a capacitor connecting between the inverting input terminal and the output terminal of the operational amplifier; and
a switch connecting in parallel with the capacitor.

11. The pixel sensor device as claimed in claim 2, wherein each second sensing pixel comprises:
a reset switch comprising the power terminal of the second sensing pixel, the reset terminal of the second sensing pixel, and a signal terminal;
a source follower connecting to the work power and the signal terminal of the reset switch of the second sensing pixel;
a selection switch connecting to the source follower of the second sensing pixel and having the selection terminal and the voltage output terminal of the second sensing pixel; and
a photo detector connecting to the reset switch of the second sensing pixel so as to store charges as the reset switch becomes conductive.

12. The pixel sensor device as claimed in claim 2, wherein each first sensing pixel is a photo detector whose cathode is used as a power terminal connecting to the first signal reading unit.

13. The pixel sensor device as claimed in claim 2, wherein each first sensing pixel comprises:
a reset switch comprising the power terminal of the first sensing pixel, the reset terminal of the first sensing pixel, and a signal terminal;
a source follower connecting to the work power and the signal terminal of the reset switch of the first sensing pixel;
a selection switch connecting to the source follower and comprising the selection terminal and the voltage output terminal of the first sensing pixel, wherein the voltage output terminal of the first sensing pixel has no connection or connects to the second control and reading unit; and
a photo detector connecting to the signal terminal of the reset switch of the second sensing pixel so as to store charges as the reset switch becomes conductive.

14. The pixel sensor device as claimed in claim 3, wherein each first sensing pixel comprises:
a reset switch comprising the power terminal of the first sensing pixel, the reset terminal of the first sensing pixel, and a signal terminal;
a source follower connecting to the work power and the signal terminal of the reset switch of the first sensing pixel;
a selection switch connecting to the source follower and comprising the selection terminal and the voltage output terminal of the first sensing pixel, wherein the voltage output terminal of the first sensing pixel has no connection or connects to the second control and reading unit; and
a photo detector connecting to the signal terminal of the reset switch of the second sensing pixel so as to store charges as the reset switch becomes conductive.

15. The pixel sensor device as claimed in claim 4, wherein each first sensing pixel comprises:
a reset switch having the reset terminal and the power terminal of the first sensing pixel; and
a photo detector connecting to the reset switch to store charges as the reset switch becomes conductive and to discharge at a rate with a positive correlation to an intensity of a light source.

16. The pixel sensor device as claimed in claim 1, wherein the first sensing unit is applied to detect ambient light for determining an intensity of the ambient light.

17. The pixel sensor device as claimed in claim 1, wherein the first sensing unit is applied to detect contractions and expansions of blood capillaries of a finger to measure a pulse.

18. The pixel sensor device as claimed in claim 1, wherein the second sensing unit is applied to detect a surface of a finger to obtain an image of a fingerprint.

19. An operating method of a pixel sensor device that has a first sensing unit and a second sensing unit, wherein the first sensing unit and the second sensing unit respectively have a plurality of first sensing pixels and a plurality of second sensing pixels, with the first sensing pixels disposed around an outer edge of the second sensing pixels so that the first sensing unit and the second sensing unit are concentric, and each of the first sensing pixels is coupled to a work power via a measuring terminal;
wherein the operating method has a first mode and a second mode, and respectively comprises the steps of:
in the first mode executing the steps of:
driving all the first sensing pixel; and
measuring the measuring terminal to obtain an output signal representing a summation of sensing currents flowing through all the first sensing pixels; and
in the second mode executing the steps of:
driving each second sensing pixel; and
measuring individually a sensing signal of each second sensing pixels.

20. The operating method as claimed in claim 19, wherein the first mode is applied to detect ambient brightness.

21. The operating method as claimed in claim 19, wherein the first mode is applied to detect contractions and expansions of blood capillaries of a finger to measure a pulse.

22. The operating method as claimed in claim 19, wherein the second mode is applied to perform fingerprint recognition.
